(19) United States
(12) Patent Application Publication
(10) Pub. No.: US 2021/0374902 A1
(43) Pub. Date: Dec. 2, 2021

(54) Method and Apparatus for Generating Sample Image and Electronic Device

(71) Applicant: Beijing Baidu Netcom Science and Technology Co., Ltd., Beijing (CN)

(72) Inventors: Sili CHEN, Beijing (CN); Zhaoliang LIU, Beijing (CN); Yang ZHAO, Beijing (CN)

(21) Appl. No.: 17/400,618

(22) Filed: Aug. 12, 2021

(30) Foreign Application Priority Data
Dec. 23, 2020 (CN) 202011536978.1

(51) Int. Cl. G06T 3/00; G06T 7/73; G06T 17/20

(52) U.S. Cl. CPC G06T 3/0031; G06T 17/20; G06T 7/75

(57) ABSTRACT

A method, apparatus, and an electronic device relate to the field of augmented reality and deep learning technologies. The method includes acquiring a first image that includes a first display plane of a target planar object, and mapping the first image, to acquire a second image including a second display plane, wherein the second image is a front view of the target planar object, and the second display plane is acquired through mapping the first display plane into the second image. The method also includes acquiring a first region in the second image, wherein the first region includes a region where the second display plane is located, and the first region is larger than the region where the second display plane is located. The method furthermore includes generating a sample image in accordance with an image of the first region.

### CROSS-REFERENCE TO RELATED APPLICATION

The present application claims priority to Chinese patent application No. 202011536978.1 filed in China on Dec. 23, 2020, the disclosure of which is incorporated in its entirety by reference herein.

### TECHNICAL FIELD

The present disclosure relates to the field of image processing technology, specifically, the field of augmented reality and deep learning technologies, and in particular to a method for generating a sample image, an apparatus for generating a sample image and an electronic device.

### BACKGROUND

An indoor planar object refers to a planar object such as a painting, a billboard, a signboard or a poster. A planar object detection network is a neural network configured to detect whether an image (captured by a camera or mobile phone, etc.) includes a target planar object (i.e., a planar object that has appeared in training data). The planar object detection network may be applied in a variety of application scenarios. For example, it may be applied in superimposing a virtual object on a detected planar object (such as superimposing an explanatory text on a famous painting in an art gallery), so as to achieve an augmented reality (AR) effect. In addition, it may further be applied to indoor positioning, navigation and other scenarios.

To train the planar object detection network, a large number of real object images are required, and target planar objects need to be annotated in the captured images to generate sufficient training data sets, so as to ensure the robustness of the planar object detection network.

### SUMMARY

A method and an apparatus for generating a sample image and an electronic device are provided in the present disclosure.

According to a first aspect of the present disclosure, a method for generating a sample image is provided. The method includes: acquiring a first image, wherein the first image includes a first display plane of a target planar object; mapping the first image, to acquire a second image including a second display plane, wherein the second image is a front view of the target planar object, and the second display plane is acquired through mapping the first display plane into the second image; acquiring a first region in the second image, wherein the first region includes a region where the second display plane is located, and the first region is larger than the region where the second display plane is located; and generating a sample image in accordance with an image of the first region.

According to a second aspect of the present disclosure, an apparatus for generating a sample image is provided. The apparatus includes: a first acquisition module, configured to acquire a first image, wherein the first image includes a first display plane of a target planar object; a mapping module, configured to map the first image, to acquire a second image including a second display plane, wherein the second image is a front view of the target planar object, and the second display plane is acquired through mapping the first display plane into the second image; a second acquisition module, configured to acquire a first region in the second image, wherein the first region includes a region where the second display plane is located, and the first region is larger than the region where the second display plane is located; and a generation module, configured to generate a sample image in accordance with an image of the first region.

According to a third aspect of the present disclosure, an electronic device is provided. The electronic device includes: at least one processor and a memory in communication connection with the at least one processor. The memory stores thereon instructions executable by the at least one processor, and the instructions, when executed by the at least one processor, cause the at least one processor to perform the method described in the first aspect.

According to a fourth aspect of the present disclosure, a non-transitory computer-readable storage medium storing computer instructions thereon is provided. The computer instructions are configured to cause a computer to perform the method described in the first aspect.

According to a fifth aspect of the present disclosure, a computer program product including a computer program is provided. The computer program is configured to be executed by a processor to implement the method described in the first aspect.

It should be appreciated that the content described in this section is not intended to identify key or important features of the embodiments of the present disclosure, nor intended to limit the scope of the present disclosure. Other features of the present disclosure are easily understood based on the following description

### BRIEF DESCRIPTION OF THE DRAWINGS

The accompanying drawings are to facilitate better understanding of solutions of the present disclosure, and shall not be construed as limiting the present disclosure. In these drawings,

FIG. 1 is a flowchart illustrating a method for generating a sample image according to an embodiment of the present disclosure;

FIG. 2a is a schematic diagram of a first image according to an embodiment of the present disclosure;

FIG. 2b is a schematic diagram of a second image according to an embodiment of the present disclosure;

FIG. 3 is a structural diagram of an apparatus for generating a sample image according to an embodiment of the present disclosure; and

FIG. 4 is a block diagram of an electronic device configured to implement the method for generating the sample image according to the embodiment of the present disclosure.

### DETAILED DESCRIPTION

The following describes exemplary embodiments of the present disclosure with reference to accompanying drawings. Various details of the embodiments of the present disclosure are included to facilitate understanding, and should be considered as being merely exemplary. Therefore, those of ordinary skill in the art should be aware that various changes and modifications may be made to the embodiments described herein without departing from the scope and spirit of the present disclosure. Likewise, for clarity and conciseness, descriptions of well-known functions and structures are omitted below.

Referring to FIG. 1, a flowchart of a method for generating a sample image according to an embodiment of the present disclosure is illustrated. As shown in FIG. 1, this embodiment provides a method for generating the sample image. The method is applied to an electronic device, and includes the following steps 101 to 104.

Step 101, acquiring a first image, wherein the first image includes a first display plane.

The method provided in the present disclosure aims to generate more sample images based on a small number of sample images, and the first image may be an image from a small number of existing sample images. The first image includes at least one first display plane. These first display planes may be display planes of different target planar objects, or display planes, at different angles, of a same target planar object. For each first display plane in the first image, a new sample image may be generated by using the method for generating the sample image in the present disclosure. The first display plane is acquired by taking photos of the target planar object, and the target planar object includes a planar object such as a painting, a billboard, a signboard, or a poster.

Step 102, mapping the first image, to acquire a second image including a second display plane, wherein the second image is a front view of the target planar object, and the second display plane is acquired through mapping the first display plane into the second image.

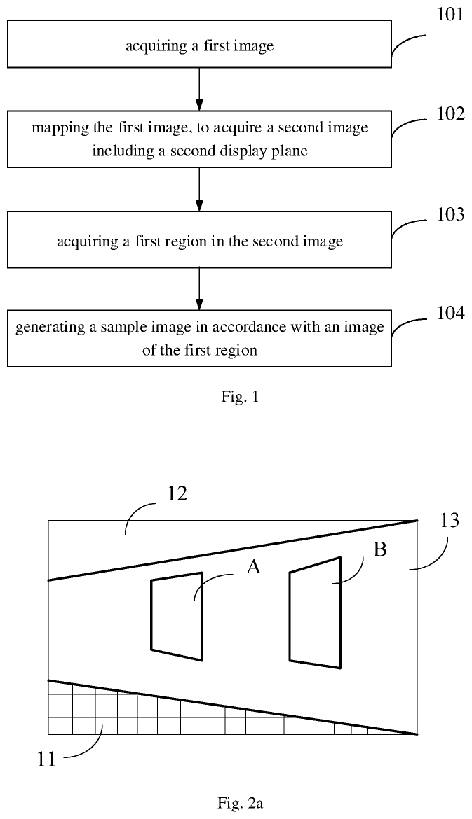

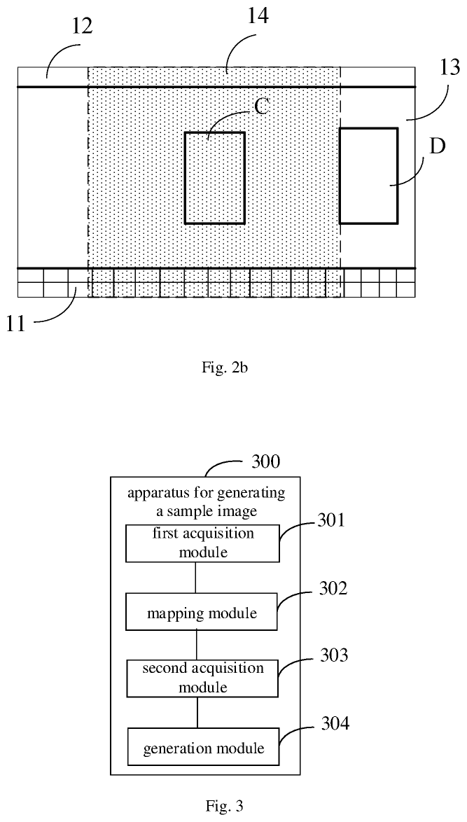

The first image is mapped, so that the target planar object is displayed in the second image in a front view perspective, that is, the second display plane is the front view of the target planar object, and the second display plane is acquired through mapping the first display plane into the second image. FIG. 2a shows a first image, FIG. 2b shows a second image, 11 denotes a floor region, 12 denotes a ceiling region, and 13 denotes a wall region. FIG. 2a shows first display planes of two posters, which are labeled as A and B respectively. FIG. 2b shows second display planes of two posters, which are labeled as C and D respectively. The first display plane labeled as A is mapped to the second display plane labeled as C, and the first display plane labeled as B is mapped to the second display plane labeled as D. The second display plane labeled as C and the second display plane labeled as D are front views of the two posters respectively.

In order to facilitate differentiating, the display plane of the target planar object in the first image is referred to as the first display plane, and the display plane of the target planar object in the second image is referred to as the second display plane.

Step 103, acquiring a first region in the second image, wherein the first region includes a region where the second display plane is located, and the first region is larger than the region where the second display plane is located.

The region where the second display plane is located may be at a central position of the first region, for example, a central position of the second display plane overlaps the central position of the first region. Further, the first region does not include a region where other display planes in the second image are located. For example, in the case that there are a plurality of first display planes in the first image, each first display plane is mapped into the second image, so that the second image includes a plurality of second display planes, and the region where other display planes in the second image are located refers to a region where second display planes other than the second display plane currently of interest are located. The second display plane currently of interest is the second display plane included in the first region. As shown in FIG. 2b, in the case that the second display plane labeled as C is currently of interest, the second display plane labeled as D falls into other display planes.

Step 104, generating a sample image in accordance with an image of the first region.

The first region may be cropped from the second image, so as to acquire the image of the first region, and the sample image may be generated based on the image of the first region. For example, random projective transformation and random illumination transformation may be performed on the image of the first region, so as to acquire the sample image.

Further, the acquired sample image and a small number of existing sample images may be used as a training set, to train a planar object detection network model, thereby improving the robustness of the planar object detection network model.

In the embodiment, the first image including the first display plane of the target planar object is acquired, the first image is mapped, so as to acquire the second image including the second display plane, wherein the second image is the front view of the target planar object, and the second display plane is acquired through mapping the first display plane into the second image; the first region in the second image is acquired, wherein the first region includes the region where the second display plane is located, and the first region is larger than the region where the second display plane is located; and the sample image is generated in accordance with the image of the first region. In this way, the sample image may be generated based on the existing first image, thus the cost, such as time cost and labor cost, of acquisition of the sample image is reduced, and the efficiency of acquisition of the sample image is improved.

In an embodiment of the present disclosure, the step 101 of acquiring the first image includes: acquiring the first image from an image data set, wherein the image data set includes the first image and a third image, both the first image and the third image include a display plane of the target planar object, and a posture of the display plane of the target planar object in the first image is different from a posture of the display plane of the target planar object in the third image.

The method in the present disclosure aims to generate more sample images based on a small number of sample images, and the first image may be an image from a small number of existing sample images. The image data set includes a small number of sample images, and the images in the image data set may be annotated images, for example, vertex positions of the first display plane in the image are annotated.

For a same target planar object, at least two images in the image data set include the display planes of the target planar object, and the display planes of the target planar object in the at least two images have different postures. That is, the image data set includes the first image and the third image. The first image and the third image each includes a display plane of the target planar object, and the display plane of the target planar object in the first image and the display plane of the target planar object in the third image have different postures, such as, different rotation angles and translation amounts.

The display plane of the target planar object in the first image is referred to as the first display plane, the first display plane is acquired by taking photos of the target planar object, and the target planar object includes a planar object such as a painting, a billboard, a signboard, or a poster. Further, the display plane in the third image may be acquired by taking photos of the target planar object as well. Images in the image data set may all be considered as the first images, that is, when the third image in the image data set is being processed, a new sample image may be generated by using the mode in which the first image is processed, so that the sample images generated based on the image data set are of great variety.

In the embodiment, the first image is acquired from the image data set, wherein the image data set includes the first image and the third image, and the first image and the third image each includes the display plane of the target planar object, and the posture of the display plane of the target planar object in the first image is different from the posture of the display plane of the target planar object in the third image. Thus, the sample images acquired subsequently may be of great variety, and the robustness of the planar object detection network model may be improved in the case that the planar object detection network model is trained by using the sample images.

In an embodiment of the present disclosure, the first image further includes first vertex positions of the first display plane, and the step 102 of mapping the first image to acquire the second image including the second display plane includes: determining second vertex positions in the second image that the first vertex positions are mapped to; determining, in accordance with the first vertex positions and the second vertex positions, a projective transformation of the first display plane mapped from the first image to the second image; and mapping, in accordance with the projective transformation, the first image to acquire the second image including the second display plane.

In the above, the vertex position of the first display plane is referred to as the first vertex position, and the first display plane may have a plurality of first vertex positions. For example, in FIG. 2a, the first display plane labeled as A has four first vertex positions. Further, the first display plane includes at least four first vertex positions. The first vertex positions may be annotated manually in advance.

In the embodiment, the first vertex positions are mapped to the second vertex positions in the second image, and the projective transformation from the first image to the second image may be calculated and acquired in accordance with the first vertex positions in the first image and the second vertex positions in the second image. Then the first image is mapped in accordance with the projective transformation, so as to acquire the second image. The second display plane in the second image is acquired through performing projective transformation on the first display plane in the first image.

In the above, the first vertex positions of the first display plane are mapped, so as to acquire the second vertex positions. Next, the projective transformation is acquired based on the first vertex positions and the second vertex positions, and the first image is mapped in accordance with the projective transformation, so as to acquire the second image. The process to acquire the second image has an easy calculation and high processing efficiency, thus the efficiency of the subsequent acquisition of the sample image may be improved.

In an embodiment of the present disclosure, the determining the second vertex positions in the second image that the first vertex positions are mapped to includes: acquiring three-dimensional space positions corresponding to the first vertex positions in accordance with the first vertex positions; acquiring a length-to-width ratio of the first display plane in accordance with the three-dimensional space positions; determining, in accordance with the length-to-width ratio and a size of the first image, a size of the first display plane mapped into the second image; and determining, in accordance with the size of the first display plane mapped into the second image, the second vertex positions in the second image that the first vertex positions are mapped to.

As shown in FIG. 2a, the first display plane includes four first vertex positions, and the positions, in the three-dimensional space, of the four first vertices are calculated. A calculation mode is not limited in the present disclosure. For example, a Structure-From-Motion (SFM) algorithm may be used. Each first vertex position corresponds to a position in the three-dimensional space, and the four first vertex positions correspond to four three-dimensional space positions respectively. According to the four three-dimensional space positions, the length-to-width ratio of the first display plane may be calculated. The size of the first display plane mapped into the second image, i.e., a size of the second display plane, may be determined in accordance with the length-to-width ratio and the size of the first image.

For example, in the case that the length-to-width ratio is 1:2 and the size of the first image is 640×480, a length of the target planar object in the front view (i.e., the second image) may be set as 150 and a width thereof may be set as 300. That is, the second display plane is of the above length and width. In the case that the central position of the second display plane is overlapped with a central position of the second image, coordinates of the center point are (x, y)=(320, 240), and coordinates of a top left vertex of the second display plane (i.e., a second vertex position) is (320−(150/2), 240−(300/2))=(245, 90), coordinates of the other three vertices of the second display plane may be acquired in the same way.

The process of determining the second vertex positions in the second image that the first vertex positions are mapped to in the embodiment has a simple and efficient calculation, so as to improve the efficiency of the subsequent acquisition of the sample image.

In an embodiment of the present disclosure, the step 103 of acquiring the first region in the second image includes: acquiring a boundary region through extending, in a direction away from the region where the second display plane is located, from a starting position, which is a boundary of the region where the second display plane is located, to a boundary of the second image, or, to a boundary of a region where other display planes are located in the second image, wherein the second display plane is located in the middle of the boundary region; determining the first region within the boundary region, wherein the first region includes the region where the second display plane is located, and the first region is larger than the region where the second display plane is located

In the above, the first region is selected within the boundary region, and may not go beyond the boundary region. The first region includes the region where the second display plane is located, and the first region is larger than the region where the second display plane is located, and is smaller than or equal to the boundary region. Preferably, the second display plane is located at the central position of the first region, for example, the central position of the second display plane overlaps the central position of the first region, and each edge of the second display plane is parallel to a corresponding edge of the first region.

The second display plane is located in the middle of the boundary region, which means that the region where the second display plane is located is at the central position of the boundary region. For example, the central position of the second display plane overlaps the central position of the boundary region, and each edge of the second display plane is parallel to a corresponding edge of the boundary region. That the second display plane is located in the middle of the boundary region may also be construed as that the region where the second display plane is located is adjacent to the central position of the boundary region. For example, a distance between the central position of the second display plane and the central position of the boundary region is less than a preset threshold, and each edge of the second display plane is parallel to the corresponding edge of the boundary region.

As shown in FIG. 2b, a region enclosed by a dashed box denoted by 14 is the boundary region acquired in the above mode. The first region may be randomly selected within the boundary region, and the following conditions need to be met: the first region includes the region where the second display plane is located, the first region is larger than the region where the second display plane is located, and the first region does not exceed the boundary region.

In the embodiment, the set boundary region does not include other display planes, so as to avoid that the acquired first region includes other display planes, thereby reducing the interference caused by other display planes in the generated sample image, and improving the usability of the sample image.

In an embodiment of the present disclosure, the step 104 of generating the sample image in accordance with the image of the first region includes: acquiring the image of the first region in the second image; acquiring a first intermediate image through performing random projective transformation on the image of the first region; acquiring a second intermediate image through adding a pre-acquired background image to the first intermediate image; and acquiring the sample image through performing random illumination transformation on the second intermediate image.

Specifically, after the first region is determined, the first region may be cropped from the second image, so as to acquire the image of the first region (a region image, for short, hereinafter), and the first intermediate image may be acquired through performing random projective transformation on the region image. Next, the second intermediate image may be acquired through pasting the first intermediate image to the pre-acquired background image, and random illumination transformation may be performed on the second intermediate image to finally acquire the sample image. The random illumination transformation may be realized by using a transformation function under the framework of neural network, which will not be particularly limited herein.

In the above, after the first region is determined, such processing as random projective transformation, adding the background image and random illumination transformation may be performed on the image of the first region, so as to simulate a real scenario and acquire diverse sample images, thereby improving the scenario coverage rate of the sample images in the training set of the planar object detection network model, and ultimately improving the robustness of the planar object detection network model.

The method for generating the sample image in the present disclosure will be illustrated below by way of example.

The method for generating the sample image provided in the present disclosure may generate more training data (i.e., the sample images) based on a small amount of annotated data (i.e., the first images), so as to reduce the cost of generation of the training data set.

Hereinafter, a small data set collected and annotated manually is referred to as a data set S. A generated large data set having more images and having undergone more transformations is referred to as a data set L.

The images in the data set S need to meet the following condition: a same target planar object needs to appear in at least two images of the data set with different postures, such as, different rotation angles and/or different translation amounts.

The process of generating the data set L in accordance with the data set S may be as follows.

For each image (i.e., the first image) in the data set S, the first display plane of the target planar object in the first image is transformed into the second display plane by using the acquired projective transformation. The second display plane is the front view of the target planar object. It should be appreciated that each first display plane corresponds to one projective transformation, and the first image may be mapped to the second image in accordance with the projective transformation. The first display plane in the first image may be manually annotated, so as to annotate the vertex positions of the first display plane.

In the case that there are n first display planes in the first image, n front views (i.e., the second images) are generated, i.e., each first display plane corresponds to one second image, and n is a positive integer.

The projective transformation may be calculated as follows.

Three-dimensional (3D) space positions of four annotated corner points (i.e., the four vertices of the first display plane) of one target planar object in the first image are calculated. There are many calculation methods, which are not particularly limited in the present disclosure. For example, the SFM algorithm may be used to calculate a relative pose R (which refers to a rotation matrix) and t (which refers to a translation vector), and then the 3D space positions may be acquired through triangulation in accordance with R, t and the four vertex positions of the first display plane.

A length-to-width ratio of the target planar object is calculated in accordance with the 3D space positions of the four corner points.

The size of the target planar object in the front view may be set in accordance with the length-to-width ratio and the size of the first image, so as to calculate coordinates (which are two-dimensional coordinates) of the four corner points of the target planar object in the front view.

For example, in the case that the length-to-width ratio is 1:2 and the size of the first image is 640×480, a length of the target planar object in the front view (i.e., the second image) may be set as 150 and a width thereof may be set as 300. That is, the second display plane is of the above length and width. In the case that the central position of the second display plane is overlapped with a central position of the second image, coordinates of the center point are (x, y)=(320, 240), and coordinates of a top left vertex of the second display plane (i.e., the second vertex position) is (320−(150/2), 240−(300/2))=(245, 90), coordinates of the other three vertices of the second display plane may be acquired in the same way.

In accordance with the coordinates of the four corner points in the front view and the coordinates of the corresponding four annotated corner points of the first display plane, the projective transformation from the first image to the second image may be calculated and acquired. The projective transformation has 8 degrees of freedom, and may be calculated based on four points of which any three points are not collinear.

For the first display plane of each target planar object, the corresponding projective transformation may be acquired by using the above calculation method.

A value range of the first region in the front view is determined. The first region includes the region where the second display plane is located, the first region is larger than the region where the second display plane is located, and the first region is smaller than or equal to the boundary region.

In the above example, the region where the second display plane is located is a rectangular region composed of four corner points: (245, 90), (245, 390), (395, 390) and (395, 90).

The boundary region may be a maximum rectangular region which is centered at the region where the second display plane is located, and which is formed by extending outwards to the image boundary, or extending outwards until another planar object is reached. For a specific description, reference may be made to the description related to FIG. 2b.

A region is selected randomly within the value range of the first region, random projective transformation is performed on the region, and then the region is pasted onto a random background image. Next, random illumination transformation (which may be realized by using a transformation function under the framework of neural network, such as transforms. ColorJitter in pytorch) may be performed, so as to acquire the sample image. The above process of randomly generating the sample image may be performed offline or online.

In the above process, more training data may be automatically generated by using a small amount of annotated data, thus the training acquires a robust planar object detection network model, thereby reducing the cost of generation of the training data set.

Referring to FIG. 3, a structural diagram of an apparatus for generating a sample image according to an embodiment of the present disclosure is illustrated. As shown in FIG. 3, the embodiment provides an apparatus 300 for generating the sample image. The apparatus 300 is implemented by an electronic device, and includes: a first acquisition module 301, configured to acquire a first image, wherein the first image includes a first display plane of a target planar object; a mapping module 302, configured to map the first image, to acquire a second image including a second display plane, wherein the second image is a front view of the target planar object, and the second display plane is acquired through mapping the first display plane into the second image; a second acquisition module 303, configured to acquire a first region in the second image, wherein the first region includes a region where the second display plane is located, and the first region is larger than the region where the second display plane is located; and a generation module 304, configured to generate a sample image in accordance with an image of the first region.

Further, the first acquisition module includes: a first acquisition sub-module, configured to acquire a boundary region through extending, in a direction away from the region where the second display plane is located, from a starting position, which is a boundary of the region where the second display plane is located, to a boundary of the second image, or, to a boundary of a region where another display plane is located in the second image, wherein the second display plane is located in the middle of the boundary region; and a first determination sub-module, configured to determine the first region within the boundary region, wherein the first region includes the region where the second display plane is located, and the first region is larger than the region where the second display plane is located.

Further, the first image further includes first vertex positions of the first display plane, and the mapping module 302 includes: a second determination sub-module, configured to determine second vertex positions in the second image that the first vertex positions are mapped to; a third determination sub-module, configured to determine, in accordance with the first vertex positions and the second vertex positions, a projective transformation of the first display plane mapped from the first image to the second image; and a mapping sub-module, configured to map, in accordance with the projective transformation, the first image to acquire the second image including the second display plane.

Further, the second determination sub-module includes: a first acquisition unit, configured to acquire three-dimensional space positions corresponding to the first vertex positions in accordance with the first vertex positions; a second acquisition unit, configured to acquire a length-to-width ratio of the first display plane in accordance with the three-dimensional space positions; a first determination unit, configured to determine, in accordance with the length-to-width ratio and a size of the first image, a size of the first display plane mapped into the second image; and a second determination unit, configured to determine, in accordance with the size of the first display plane mapped into the second image, the second vertex positions in the second image that the first vertex positions are mapped to.

Further, the first acquisition module 301 is configured to acquire the first image from an image data set, wherein the image data set includes the first image and a third image, both the first image and the third image include a display plane of the target planar object, and a posture of the display plane of the target planar object in the first image is different from a posture of the display plane of the target planar object in the third image.

Further, the generation module 304 includes: a second acquisition sub-module, configured to acquire the image of the first region in the second image; a third acquisition sub-module, configured to acquire a first intermediate image through performing random projective transformation on the image of the first region; a four acquisition sub-module, configured to acquire a second intermediate image through adding a pre-acquired background image to the first intermediate image; and a fifth acquisition sub-module, configured to acquire the sample image through performing random illumination transformation on the second intermediate image.

In the apparatus 300 for generating the sample image according to the embodiment of the present disclosure, the first image including the first display plane of the target planar object is acquired, the first image is mapped, to acquire the second image including the second display plane, wherein the second image is the front view of the target planar object, and the second display plane is acquired through mapping the first display plane into the second image; the first region in the second image is acquired, wherein the first region includes the region where the second display plane is located, and the first region is larger than the region where the second display plane is located; and the sample image is generated in accordance with the image of the first region. In this way, the sample image may be generated based on the existing first image, thus the time cost and labor cost of acquisition of the sample image is reduced, and the efficiency of acquisition of the sample image is improved.

According to the embodiment of the present application, an electronic device, a computer program product and a readable storage medium are further provided.

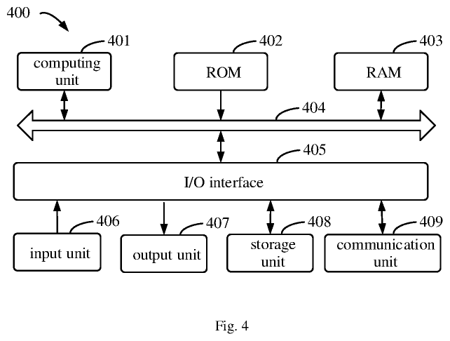

FIG. 4 shows a block diagram of an exemplary electronic device 400 for implementing the embodiment of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as personal digital assistant, cellular telephones, smart phones, wearable devices, and other similar computing devices. The components shown herein, their connections and relationships, and their functions are by way of example only and are not intended to limit the implementations of the present disclosure described and/or claimed herein.

As shown in FIG. 4, the electronic device 400 includes a computing unit 401, the computing unit 401 may perform various appropriate operations and processing based on a computer program stored in a read only memory (ROM) 402 or a computer program loaded from a storage unit 408 to a random access memory (RAM) 403. In the RAM 403, various programs and data required for the operation of the electronic device 400 may also be stored. The computing unit 401, the ROM 402 and the RAM 403 are connected to each other through a bus 404. An input/output (I/O) interface 405 is also connected to the bus 404.

A plurality of components in the electronic device 400 are connected to the I/O interface 405. The components include: an input unit 406, such as a keyboard or a mouse; an output unit 407, such as various types of displays or speakers; a storage unit 408, such as a magnetic disk or an optical disc; and a communication unit 409, such as a network card, a modem, or a wireless communication transceiver. The communication unit 409 allows the electronic device 400 to exchange information/data with other devices through a computer network such as the Internet and/or various telecommunication networks.

The computing unit 401 may be various general-purpose and/or dedicated processing components having processing and computing capabilities. Some examples of the computing unit 401 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 401 performs the various methods and processing described above, such as the method for generating the sample image. For example, the method for generating the sample image may be implemented as a computer software program in some embodiments, which is tangibly included in a machine-readable medium, such as the storage unit 408. In some embodiments, a part or all of the computer program may be loaded and/or installed on the electronic device 400 through the ROM 402 and/or the communication unit 409. When the computer program is loaded into the RAM 403 and executed by the computing unit 401, one or more steps of the foregoing method for generating the sample image may be implemented. Optionally, in other embodiments, the computing unit 401 may be configured in any other suitable manner (for example, by means of firmware) to perform the method for generating the sample image.

Various embodiments of the systems and techniques described herein may be implemented in a digital electronic circuitry, an integrated circuit system, a field programmable gate array (FPGA), an application-specific integrated circuits (ASIC), an application-specific standard products (ASSP), a system on chip (SOC), a complex programmable logic device (CPLD), computer hardware, firmware, software, and/or a combination thereof. These various embodiments may include implementation in one or more computer programs that may be executed and/or interpreted on a programmable system including at least one programmable processor. The programmable processor may be a dedicated or general purpose programmable processor, may receive data and instructions from a storage system, at least one input device and at least one output device, and transmit data and instructions to the storage system, the at least one input device and the at least one output device.

Program codes used to implement the method of the present disclosure may be written in any combination of one or more programming languages. These program codes may be provided to the processor or controller of the general-purpose computer, the dedicated computer, or other programmable data processing devices, so that when the program codes are executed by the processor or controller, functions/operations specified in the flowcharts and/or block diagrams are implemented. The program codes may be run entirely on a machine, run partially on the machine, run partially on the machine and partially on a remote machine as a standalone software package, or run entirely on the remote machine or server.

In the context of the present disclosure, the machine readable medium may be a tangible medium, and may include or store a program used by an instruction execution system, device or apparatus, or a program used in conjunction with the instruction execution system, device or apparatus. The machine readable medium may be a machine readable signal medium or a machine readable storage medium. The machine readable medium includes, but is not limited to: an electronic, magnetic, optical, electromagnetic, infrared, or semiconductor system, device or apparatus, or any suitable combination thereof. A more specific example of the machine readable storage medium includes: an electrical connection based on one or more wires, a portable computer disk, a hard disk, a random access memory (RAM), a read only memory (ROM), an erasable programmable read only memory (EPROM or flash memory), an optic fiber, a portable compact disc read only memory (CD-ROM), an optical storage device, a magnetic storage device, or any suitable combination thereof.

To facilitate user interaction, the system and technique described herein may be implemented on a computer. The computer is provided with a display device (for example, a cathode ray tube (CRT) or liquid crystal display (LCD) monitor) for displaying information to a user, a keyboard and a pointing device (for example, a mouse or a track ball). The user may provide an input to the computer through the keyboard and the pointing device. Other kinds of devices may be provided for user interaction, for example, a feedback provided to the user may be any manner of sensory feedback (e.g., visual feedback, auditory feedback, or tactile feedback); and input from the user may be received by any means (including sound input, voice input, or tactile input).

The system and technique described herein may be implemented in a computing system that includes a back-end component (e.g., as a data server), or that includes a middle-ware component (e.g., an application server), or that includes a front-end component (e.g., a client computer having a graphical user interface or a Web browser through which a user can interact with an implementation of the system and technique), or any combination of such back-end, middleware, or front-end components. The components of the system can be interconnected by any form or medium of digital data communication (e.g., a communication network). Examples of communication networks include a local area network (LAN), a wide area network (WAN) and the Internet.

The computer system can include a client and a server. The client and server are generally remote from each other and typically interact through a communication network. The relationship of client and server arises by virtue of computer programs running on respective computers and having a client-server relationship to each other. The server may be a cloud server, also referred to as a cloud computing server or a cloud host, and is a host product in a cloud computing service system, so as to solve the defects such as a difficulty in management and weak service scalability in a conventional physical host and Virtual Private Server (VPS) service. The server may also be a server of a distributed system, or a server combined with a blockchain.

It is appreciated, all forms of processes shown above may be used, and steps thereof may be reordered, added or deleted. For example, as long as expected results of the technical solutions of the present disclosure can be achieved, steps set forth in the present disclosure may be performed in parallel, performed sequentially, or performed in a different order, and there is no limitation in this regard.

The foregoing specific implementations constitute no limitation on the scope of the present disclosure. It is appreciated by those skilled in the art, various modifications, combinations, sub-combinations and replacements may be made according to design requirements and other factors. Any modifications, equivalent replacements and improvements made without deviating from the spirit and principle of the present disclosure shall be deemed as falling within the scope of the present disclosure.

What is claimed is:

1. A method for generating a sample image, comprising:
acquiring a first image, wherein the first image comprises a first display plane of a target planar object;
mapping the first image to acquire a second image comprising a second display plane, wherein the second image is a front view of the target planar object, and the second display plane is acquired through mapping the first display plane into the second image;
acquiring a first region in the second image, wherein the first region comprises a region where the second display plane is located, and the first region is larger than the region where the second display plane is located; and
generating the sample image in accordance with an image of the first region.

2. The method according to claim 1, wherein acquiring the first region in the second image comprises:
acquiring a boundary region through extending, in a direction away from the region where the second display plane is located, from a starting position, which is a boundary of the region where the second display plane is located, to a boundary of the second image, or, to a boundary of a region where another display plane is located in the second image, wherein the second display plane is located in the middle of the boundary region; and
determining the first region within the boundary region.

3. The method according to claim 1, wherein the first image further comprises first vertex positions of the first display plane, and mapping the first image to acquire the second image comprising the second display plane comprises:
determining second vertex positions in the second image that the first vertex positions are mapped to;
determining, in accordance with the first vertex positions and the second vertex positions, a projective transformation of the first display plane mapped from the first image to the second image; and
mapping, in accordance with the projective transformation, the first image to acquire the second image comprising the second display plane.

4. The method according to claim 3, wherein determining the second vertex positions in the second image that the first vertex positions are mapped to comprises:
acquiring, in accordance with the first vertex positions, three-dimensional space positions corresponding to the first vertex positions;
acquiring a length-to-width ratio of the first display plane in accordance with the three-dimensional space positions;
determining, in accordance with the length-to-width ratio and a size of the first image, a size of the first display plane mapped into the second image; and
determining, in accordance with the size of the first display plane mapped into the second image, the second vertex positions of the first display plane mapped into the second image.

5. The method according to claim 1, wherein acquiring the first image comprises:
acquiring the first image from an image data set, wherein the image data set comprises the first image and a third image, each of the first image and the third image comprises a display plane of the target planar object, and a posture of the display plane of the target planar object in the first image is different from a posture of the display plane of the target planar object in the third image.

6. The method according to claim 1, wherein generating the sample image in accordance with the image of the first region comprises:
acquiring the image of the first region in the second image;
acquiring a first intermediate image through performing random projective transformation on the image of the first region;
acquiring a second intermediate image through adding a pre-acquired background image to the first intermediate image; and
acquiring the sample image through performing random illumination transformation on the second intermediate image.

7. An electronic device, comprising:
at least one processor; and
a memory in communication connection with the at least one processor; wherein, the memory stores thereon instructions executable by the at least one processor, and the instructions, when executed by the at least one processor, cause the at least one processor to implement a method for generating a sample image, and the method comprises,
acquiring a first image, wherein the first image comprises a first display plane of a target planar object,
mapping the first image to acquire a second image comprising a second display plane, wherein the second image is a front view of the target planar object, and the second display plane is acquired through mapping the first display plane into the second image,
acquiring a first region in the second image, wherein the first region comprises a region where the second display plane is located, and the first region is larger than the region where the second display plane is located, and
generating the sample image in accordance with an image of the first region.

8. The electronic device according to claim 7, wherein acquiring the first region in the second image comprises:
acquiring a boundary region through extending, in a direction away from the region where the second display plane is located, from a starting position, which is a boundary of the region where the second display plane is located, to a boundary of the second image, or, to a boundary of a region where another display plane is located in the second image, wherein the second display plane is located in the middle of the boundary region; and
determining the first region within the boundary region.

9. The electronic device according to claim 7, wherein the first image further comprises first vertex positions of the first display plane, and mapping the first image to acquire the second image comprising the second display plane comprises:
determining second vertex positions in the second image that the first vertex positions are mapped to;
determining, in accordance with the first vertex positions and the second vertex positions, a projective transformation of the first display plane mapped from the first image to the second image; and
mapping, in accordance with the projective transformation, the first image to acquire the second image comprising the second display plane.

10. The electronic device according to claim 9, wherein determining the second vertex positions in the second image that the first vertex positions are mapped to comprises:
acquiring, in accordance with the first vertex positions, three-dimensional space positions corresponding to the first vertex positions;
acquiring a length-to-width ratio of the first display plane in accordance with the three-dimensional space positions;
determining, in accordance with the length-to-width ratio and a size of the first image, a size of the first display plane mapped into the second image; and
determining, in accordance with the size of the first display plane mapped into the second image, the second vertex positions of the first display plane mapped into the second image.

11. The electronic device according to claim 7, wherein acquiring the first image comprises:
acquiring the first image from an image data set, wherein the image data set comprises the first image and a third image, each of the first image and the third image comprises a display plane of the target planar object, and a posture of the display plane of the target planar object in the first image is different from a posture of the display plane of the target planar object in the third image.

12. The electronic device according to claim 7, wherein generating the sample image in accordance with the image of the first region comprises:
acquiring the image of the first region in the second image;
acquiring a first intermediate image through performing random projective transformation on the image of the first region;
acquiring a second intermediate image through adding a pre-acquired background image to the first intermediate image; and
acquiring the sample image through performing random illumination transformation on the second intermediate image.

13. A non-transitory computer-readable storage medium storing computer instructions thereon, wherein the computer instructions are configured to cause a computer to perform the method according to claim 1.

14. A computer program product, comprising a computer program, wherein the computer program is configured to be executed by a processor to implement the method according to claim 1.
